(19) United States
(12) Patent Application Publication
(10) Pub. No.: US 2025/0249885 A1
(43) Pub. Date: Aug. 7, 2025

(54) ENERGY-EFFICIENT VEHICULAR DISTRIBUTED MACHINE LEARNING

(71) Applicant: TOYOTA MOTOR ENGINEERING & MANUFACTURING NORTH AMERICA, INC., PLANO, TX (US)

(72) Inventors: CHIANING WANG, Mountain View, CA (US); EVAN KING, Austin, TX (US); ALEXANDER T. PHAM, San Jose, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHi (JP)

(21) Appl. No.: 18/430,491

(22) Filed: Feb. 1, 2024

(51) Int. Cl. B60W 20/11; G07C 5/00; G07C 5/08

(52) U.S. Cl. CPC B60W 20/11; G07C 5/008; G07C 5/08; B60W 2556/10

(57) ABSTRACT

Systems and methods are provided for vehicular distributed machine learning that balances a tradeoff between electrical energy consumed for training a machine learning model and performance of the training. Examples include obtaining model training metrics associated with vehicles, wherein the model training metrics are based on a measure of diversity in training data stored at each respective vehicle and an estimate of energy that the vehicle may consume to train the machine learning model. The examples select a vehicle as a training client based on the obtained first one or more model training metrics; and transmit the machine learning model to the selected vehicle for training by the vehicle.

### TECHNICAL FIELD

The present disclosure relates generally to systems and methods for machine learning, and, more particularly, some embodiments relate to energy efficient distributed machine learning.

### DESCRIPTION OF RELATED ART

Machine learning (ML) approaches train mathematical models to perform tasks, such as making predictions. Autonomous vehicles and intelligent driving-assistance systems increasingly rely on machine-learning approaches to accomplish their tasks. Conventionally, machine learning models are trained by compiling available data at a centralized cloud-based server and performing model training using the compiled data.

However, the high cost of cloud infrastructure in terms of computation resources costs and monetary costs has motivated the use of distributed machine learning (DML) for training of models. Distributed machine learning involves moving data storage and model training to one or more edge devices that provide entry points to the cloud-based server. For example, edge devices can collect data locally and perform training using local on-board computers. In vehicular applications, vehicles can be used as edge devices to collect data and performing training using distributed machine learning, which can reduce resource consumption at the centralized server. Distributed machine learning training can be coordinated by mobile edge devices (MED), such as for example, for roadside devices that wirelessly communicate with vehicles and instruct the vehicles on training. These MEDs may periodically receive updates to the distributed machine learning model from vehicles that have contributed to training it.

### BRIEF SUMMARY OF THE DISCLOSURE

According to various embodiments of the disclosed technology, systems and methods for vehicular distributed machine learning that balances a tradeoff between electrical energy consumed for training a machine learning model and performance of the training are provided.

In accordance with some embodiments, a method for distributed machine learning is provided. The method comprises obtaining, by a computing device, a first one or more model training metrics from a first one or more vehicles. Each of the first one or more model training metrics is based on diversity in training data stored at a respective vehicle of the first one or more vehicles and an estimate of energy consumed to train a machine learning model at the respective vehicle of the first one or more vehicles. The method also comprises selecting a first vehicle from the first one or more vehicles based on the obtained first one or more model training metrics, and transmitting the machine learning model to the selected first vehicle. The selected first vehicle trains the machine learning model on training data stored at the selected first vehicle.

In another aspect, a computing device is provided that comprises a memory storing instructions and a machine learning model, and one or more processors communicably coupled to the memory. The one or more processors are configured to execute the instructions to obtain one or more model training metrics from one or more vehicles. Each of the one or more model training metrics is based on a measure of entropy in training data stored at a respective vehicle of the one or more vehicles and an estimate of energy consumed to train the machine learning model at the respective vehicle of the one or more vehicles. The one or more processors are further configured to execute instructions to select a vehicle from the one or more vehicles having the largest model training metric of the obtained one or more model training metrics, and transmit the machine learning model to the selected vehicle.

In another aspect, a vehicle is provided comprising a memory storing instructions, and one or more processors communicably coupled to the memory. The one or more processors are configured to execute the instructions to, based on a model training metric associated with the vehicle, receive a machine learning model and information indicative of a performance threshold for the machine learning model, train the machine learning model, measure a performance of the trained machine learning model, and transmit the machine learning model to a remote computing device based on the measured performance being equal to or exceeding the performance threshold.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for vehicular distributed machine learning in accordance with one embodiment of the systems and methods described herein.

FIG. 3 is an example architecture of an example vehicular disturbed machine learning system in accordance with various embodiments disclosed herein.

FIG. 4 is a flow illustrating example operations performed by an example vehicular distributed machine learning system in accordance with embodiments disclosed herein.

FIGS. 5A-5B and 6A-6B depict simulation results of distributed machine learning according to the present disclosure compared to conventional systems.

FIG. 7 is flow illustrating example stoppage conditions, according to embodiments disclosed herein, for the example vehicular distributed machine learning system of FIG. 4.

FIGS. 8A and 8B depict simulation results of the stoppage conditions of FIG. 7.

FIG. 9 is an example computing component that may be used to implement various features of embodiments described in the present disclosure.

The figures are not exhaustive and do not limit the present disclosure to the precise form disclosed.

### DETAILED DESCRIPTION

Embodiments of the disclosed technology provides for distributed machine learning that reduces the electrical energy consumed while training a machine learning model. The embodiments disclosed herein can be performed by a mobile edge device (MED) and/or connected vehicles. An MED, according to certain examples, can refer to an edge server, roadside unit/equipment, or the like. In an example implementation, an MED can be configured to select a connected vehicle from one or more connected vehicles for a first stage of distributed machine learning based on a model training metric. The model training metric can be based on (i) diversity of training data stored at the vehicle that can be used to train a machine learning model and (ii) an estimate of energy that the vehicle may consume to train the machine learning model on the training data.

As alluded to above, the high cost of cloud infrastructure in terms of computation resources and monetary costs has motivated the use of distributed machine learning for training of various models. Several distributed machine learning architectures exist, such as but not limited to, fully federated distributed machine learning architecture, fully decentralized distributed machine learning architectures, and hybrid distributed machine learning architecture. Each architecture incurs its own costs and tradeoffs in performance, such as but not limited to, consuming electrical energy to train a given model.

Fully federated distributed machine learning architectures rely on a plurality of MEDs that communicate directly with vehicles via wireless vehicle-to-infrastructure (V2I) connection. Each vehicle may store its own training data used to train the model and each vehicle may provide the trained model to the MEDs. Fully federated distributed machine learning architectures can provide for efficient model convergence because an MEDs can function to aggregate models trained from a number of vehicles. While fully federated distributed machine learning architectures can provide lower cloud infrastructure cost, this type of architecture can incur costs in deploying and maintaining a number of MEDs, such as roadside infrastructure. Furthermore, fully federated distributed machine learning architecture can high experience communication overhead as compared to other distributed machine learning architecture due to the numerous communication exchanges between a number of vehicles and MEDs.

Fully decentralized distributed machine learning architectures perform model training by exchanging models between vehicles via vehicle-to-vehicle connections (V2V). A vehicle may store training data and perform model training locally on-board. The vehicle can then transmit the trained model to a next remote vehicle via V2V communication that trains the model on its locally stored training data. The process is repeated across a number of vehicles. This architecture can lower cloud infrastructure cost, as well as reduce costs incurred due to deploying numerous MEDs. However, fully decentralized distributed machine learning architectures may have unstable performance due to slow or lack of convergence in the model due to continuously trained across vehicles.

Hybrid distributed machine learning architectures attempt to combine aspects of fully federated distributed machine learning with aspects of the decentralized approach through a combination of V2V and V2I communications. For example, an MED may communicate directly with a connected vehicle via V2I communication. The vehicle trains the model on-board using its locally stored data and communicates the trained model to a next remote vehicle via V2V communications. The next vehicle trains the model on-board using its locally stored data. The model can be passed to a number of vehicles (referred to as a “hop”) and then communicated back to the MED via V2I communications. This architecture can be used to balance the infrastructure cost of fully federated architectures with the complexity of fully decentralized architectures.

While there are various trade-offs in each of the above distributed machine learning architectures, in each case vehicles involved consume electrical energy to train the machine learning models locally on-board. That is, moving data storage and training to the edge with distributed machine learning can reduce cloud infrastructure costs and improve computation resource utilization; however, model training can be a computationally heavy task that consumes electrical energy of vehicles performing the task locally. For example, in hybrid distributed machine learning architecture, an MED performs initial client selection to select a vehicle to perform a first stage of training using its locally stored training data and on-board computing devices. After training, the initial client can a choose neighboring client (e.g., a next vehicle) to perform a next stage of training. After a number of training stages have been completed, the final client (e.g., final vehicle) transmits the results of all training back to a MED. However, model training at each vehicle can consume electrical energy from batteries or other power sources on-board each vehicle. In the case of electric vehicles that are powered by batteries, energy consumption has a direct impact on traveling range.

In battery-powered electric vehicles (BEV), overall energy consumption is an important consideration. BEVs are powered solely by electrical energy from a battery or batteries. Therefore, a BEV's functionality is dependent on the charge of the battery (ies) on the vehicle. Wasteful use of this charge can result in decreased driving range, which can negatively impact a BEV's success and adoption. Thus, excessive use of electrical energy in training locally and negatively impact the driving range of a BEV.

As alluded to above, in distributed machine learning architectures, there is a tradeoff between training and energy consumption. Broadly speaking, a vehicle does not use energy to train if the vehicle does not train a model, but the model performance will not improve. Conversely, a high-performance model can be achieved through consistent training, but energy consumption is increased. Furthermore, not all training is guaranteed to improve model performance, which may be dependent on the diversity of the distribution in the training data on which the model is trained. If, for example, a computer vision model is trained to recognize road signs, a diverse set of images of various different road signs may provide for more accurate model predictions as compared to a set of images that contain a less diverse set of images. For example, if the model is trained on 1000 images of stop signs, training it on another 100 more images of stop signs is not likely to improve its performance, but will still consume energy to perform the training.

Certain conventional distributed machine learning techniques did not consider energy consumed due to training. For example, certain methods have been proposed for selecting clients in vehicular implemented distributed machine learning architecture, but these architectures do not consider energy consumption as a factor in client selection. For example, one approach proposes the use of Shannon entropy to estimate a value of a vehicle's locally stored data and chooses vehicles having the highest Shannon entropy. This approach does not consider energy consumption. In another approach, a clustering algorithm may be used to select the clients in a mobile vehicular network, but again does not consider energy consumption. Yet another approach considers battery life available and selects vehicles that has sufficient battery charge to perform training, but does not consider an estimate of energy that will be consumed to perform the training.

Some non-vehicular distributed machine learning approaches select non-vehicular (e.g., fixed location) clients based on a tradeoff between model accuracy improvement and energy consumption. However, these approaches only work in situations where all the clients have a stable network connection to the server coordinating training, which is not the case in vehicular distributed machine learning architectures where mobile vehicles regularly enter and exit the communication range of the MEDs as they drive. Additionally, this approach is based on mathematical models that ignore the impact of data distribution (e.g., Independent and Identically Distributed (IID) data vs non-IID data) on the benefit to model accuracy accrued through training. Thus, while these non-mobile approaches may consider a tradeoff between energy and performance of training, none of them apply to distributed learning with mobile vehicles and non-IID data.

Accordingly, embodiments of the presently disclosed provide for an energy-balanced client selection technique that performs client selection tailored to vehicular hybrid distributed machine learning. The disclosed embodiments operate in distributed machine learning environments that involves mobile clients, such as vehicles, with realistic data distributions, unlike the above-discussed conventional approaches. Furthermore, the conventional approaches rely on theoretical models that cannot be easily deployed in real-world architectures, for example, where clients are consistently moving in and out of communication range. Additionally, the conventional approaches do not utilize a hybrid distributed machine learning architecture, instead relying on fully federated approaches. Whereas, examples of the presently disclosed technology can be implemented in a hybrid distributed machine learning architecture, thereby providing reduce infrastructure costs as outlined above. Therefore, by implementing the technology disclosed herein, distributed machine learning can be executed on vehicles while achieving reduced energy consumption and improved model training performance.

Example embodiments disclosed here achieve the above benefits though consideration of model training metrics associated with each vehicle of a distributed machine learning architecture. For example, the present disclosure provides for obtaining model training metrics from connected vehicles. Each of the model training metrics can be based on diversity in training data stored at a respective vehicle and an estimate of energy that the respective vehicle may consume to train a machine learning model. Based on the model training metrics, a vehicle can be selected as an client for training. The vehicle can then be provided the machine learning model and execute a training stage locally using its training data. In an example, a computing device of an MED may perform initial client selection and transmit the machine learning model to an initial client. In another example, a computing device of a remote vehicle can perform client selection and transmit the machine learning model to a downstream client. Once the training is completed, based satisfying a completion criteria, a final client (e.g., final vehicle) can transmit the trained machine learning mode to the MED. The trained model can then be deployed on vehicles for controlling vehicle systems in accomplishing vehicular tasks.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

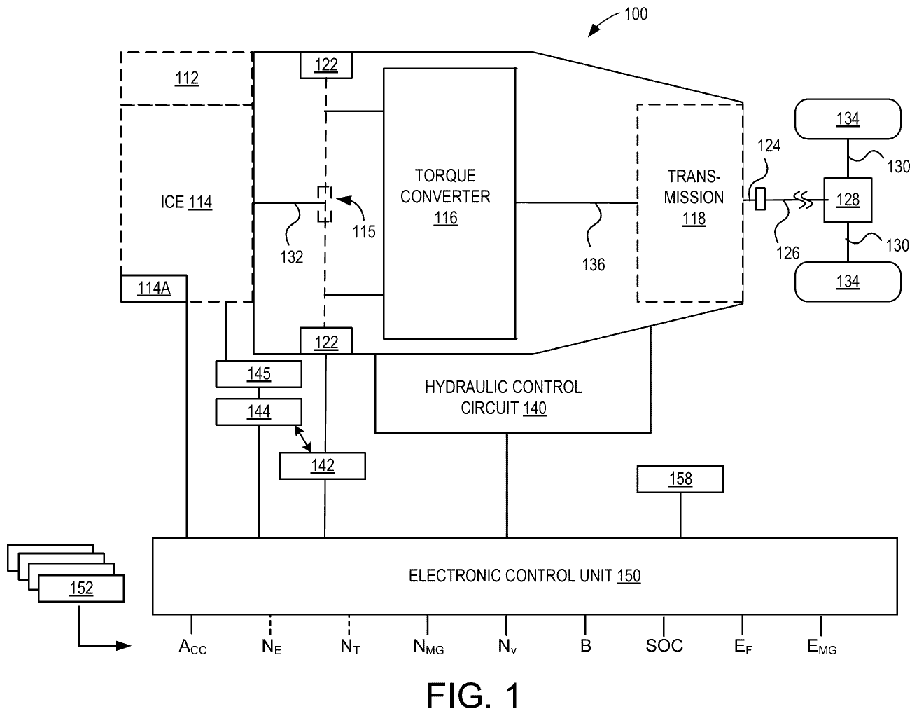

The systems and methods disclosed herein may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for distributed machine learning can be implemented in other types of vehicle including gasoline- or diesel-powered vehicles, fuel-cell vehicles, electric vehicles (e.g., BEvs), or other vehicles.

FIG. 1 illustrates a drive system of an example vehicle 100 that may include an internal combustion engine 114 and one or more electric motors 122 (which may also serve as generators) as sources of motive power. Driving force generated by the internal combustion engine 114 and motors 122 can be transmitted to one or more wheels 134 via a torque converter 116, a transmission 118, a differential gear device 128, and a pair of axles 130.

As an HEV, vehicle 100 may be driven/powered with either one of or both of engine 114 and the motor(s) 122 as the drive source for travel. For example, a first travel mode may be an engine-only travel mode that only uses internal combustion engine 114 as the source of motive power. A second travel mode may be an EV travel mode that only uses the motor(s) 122 as the source of motive power. A third travel mode may be an HEV travel mode that uses engine 114 and the motor(s) 122 as the sources of motive power. In the engine-only and HEV travel modes, vehicle 100 relies on the motive force generated at least by internal combustion engine 114, and a clutch 115 may be included to engage engine 114. In the EV travel mode, vehicle 100 is powered by the motive force generated by motor 122 while engine 114 may be stopped and clutch 115 disengaged.

Engine 114 can be an internal combustion engine such as a gasoline, diesel or similarly powered engine in which fuel is injected into and combusted in a combustion chamber. A cooling system 112 can be provided to cool the engine 114 such as, for example, by removing excess heat from engine 114. For example, cooling system 112 can be implemented to include a radiator, a water pump and a series of cooling channels. In operation, the water pump circulates coolant through the engine 114 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 114. In other applications, either or both the water pump and the fan may be operated by electric current such as from battery 144.

An output control circuit 114A may be provided to control drive (output torque) of engine 114. Output control circuit 114A may include a throttle actuator to control an electronic throttle valve that controls fuel injection, an ignition device that controls ignition timing, and the like. Output control circuit 114A may execute output control of engine 114 according to a command control signal(s) supplied from an electronic control unit 150, described below. Such output control can include, for example, throttle control, fuel injection control, and ignition timing control.

Motor 122 can also be used to provide motive power in vehicle 100 and is powered electrically via a battery 144. Battery 144 may be implemented as one or more batteries or other power storage devices including, for example, lead-acid batteries, nickel-metal hydride batteries, lithium ion batteries, capacitive storage devices, and so on. Battery 144 may be charged by a battery charger 145 that receives energy from internal combustion engine 114. For example, an alternator or generator may be coupled directly or indirectly to a drive shaft of internal combustion engine 114 to generate an electrical current as a result of the operation of internal combustion engine 114. A clutch can be included to engage/disengage the battery charger 145. Battery 144 may also be charged by motor 122 such as, for example, by regenerative braking or by coasting during which time motor 122 operate as generator.

Motor 122 can be powered by battery 144 to generate a motive force to move the vehicle and adjust vehicle speed. Motor 122 can also function as a generator to generate electrical power such as, for example, when coasting or braking. Battery 144 may also be used to power other electrical or electronic systems in the vehicle. Motor 122 may be connected to battery 144 via an inverter 142. Battery 144 can include, for example, one or more batteries, capacitive storage units, or other storage reservoirs suitable for storing electrical energy that can be used to power motor 122. When battery 144 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 150 (described below) may be included and may control the electric drive components of the vehicle as well as other vehicle components. For example, electronic control unit 150 may control inverter 142, adjust driving current supplied to motor 122, and adjust the current received from motor 122 during regenerative coasting and breaking. As a more particular example, output torque of the motor 122 can be increased or decreased by electronic control unit 150 through the inverter 142.

A torque converter 116 can be included to control the application of power from engine 114 and motor 122 to transmission 118. Torque converter 116 can include a viscous fluid coupling that transfers rotational power from the motive power source to the driveshaft via the transmission. Torque converter 116 can include a conventional torque converter or a lockup torque converter. In other embodiments, a mechanical clutch can be used in place of torque converter 116.

Clutch 115 can be included to engage and disengage engine 114 from the drivetrain of the vehicle. In the illustrated example, a crankshaft 132, which is an output member of engine 114, may be selectively coupled to the motor 122 and torque converter 116 via clutch 115. Clutch 115 can be implemented as, for example, a multiple disc type hydraulic frictional engagement device whose engagement is controlled by an actuator such as a hydraulic actuator. Clutch 115 may be controlled such that its engagement state is complete engagement, slip engagement, and complete disengagement complete disengagement, depending on the pressure applied to the clutch. For example, a torque capacity of clutch 115 may be controlled according to the hydraulic pressure supplied from a hydraulic control circuit (not illustrated). When clutch 115 is engaged, power transmission is provided in the power transmission path between the crankshaft 132 and torque converter 116. On the other hand, when clutch 115 is disengaged, motive power from engine 114 is not delivered to the torque converter 116. In a slip engagement state, clutch 115 is engaged, and motive power is provided to torque converter 116 according to a torque capacity (transmission torque) of the clutch 115.

As alluded to above, vehicle 100 may include an electronic control unit 150. Electronic control unit 150 may include circuitry to control various aspects of the vehicle operation. Electronic control unit 150 may include, for example, a microcomputer that includes a one or more processing units (e.g., microprocessors), memory storage (e.g., RAM, ROM, etc.), and I/O devices. The processing units of electronic control unit 150, execute instructions stored in memory to control one or more electrical systems or subsystems 158 in the vehicle. Electronic control unit 150 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 150 receives information from a plurality of sensors included in vehicle 100. For example, electronic control unit 150 may receive signals that indicate vehicle operating conditions or characteristics, or signals that can be used to derive vehicle operating conditions or characteristics. These may include, but are not limited to accelerator operation amount (A_{CC}), a revolution speed (N_{E}) of internal combustion engine 114 (engine RPM), a rotational speed (N_{MG}) of the motor 122 (motor rotational speed), and vehicle speed (N_{V}). These may also include torque converter 116 output (N_{T}) (e.g., output amps indicative of motor output), brake operation amount/pressure (B), battery SOC (i.e., the charged amount for battery 144 detected by an SOC sensor). Accordingly, vehicle 100 can include a plurality of sensors 152 that can be used to detect various conditions internal or external to the vehicle and provide sensed conditions to engine control unit 150 (which, again, may be implemented as one or a plurality of individual control circuits). In one embodiment, sensors 152 may be included to detect one or more conditions directly or indirectly such as, for example, fuel efficiency (Er), motor efficiency (EMG), hybrid (internal combustion engine 114+MG 122) efficiency, acceleration, etc.

In some embodiments, one or more of the sensors 152 may include their own processing capability to compute the results for additional information that can be provided to electronic control unit 150. In other embodiments, one or more sensors may be data-gathering-only sensors that provide only raw data to electronic control unit 150. In further embodiments, hybrid sensors may be included that provide a combination of raw data and processed data to electronic control unit 150. Sensors 152 may provide an analog output or a digital output.

Sensors 152 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect objects in an environment surrounding vehicle 100, for example, traffic signs indicating a current speed limit, road curvature, obstacles, surrounding vehicles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

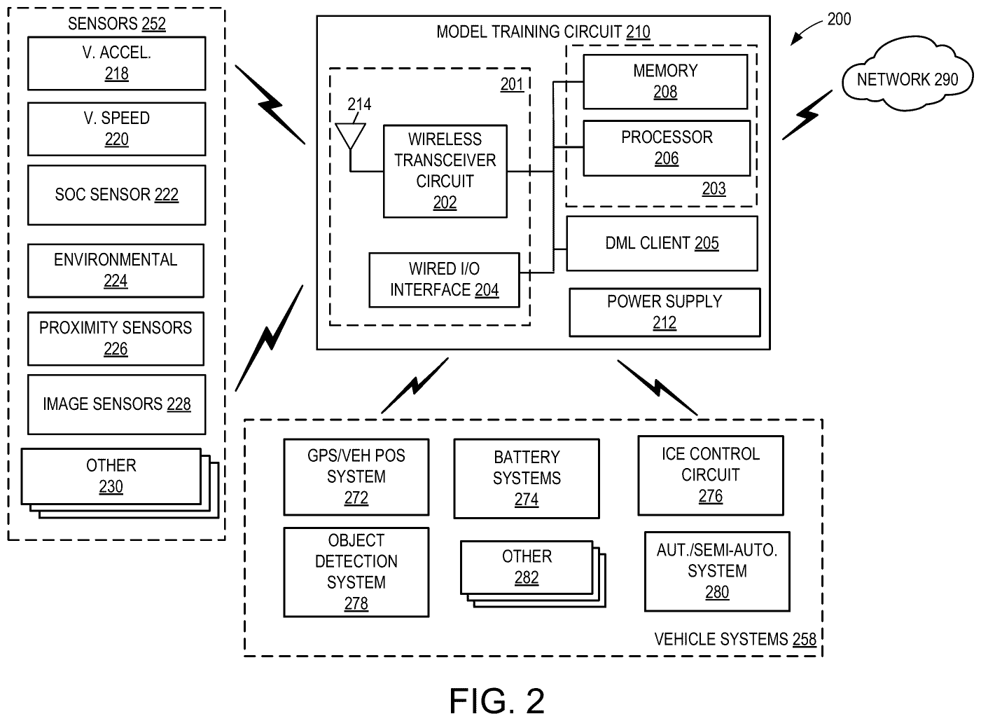

FIG. 2 illustrates an example architecture for vehicular distributed machine learning in accordance with one embodiment of the systems and methods described herein. Referring now to FIG. 2, in this example, distributed machine learning system 200 includes a machine learning circuit 210, a plurality of sensors 252 and a plurality of vehicle systems 258. Sensors 252 (such as sensors 152 described in connection with FIG. 1) and vehicle systems 258 (such as subsystems 158 described in connection with FIG. 1) can communicate with machine learning circuit 210 via a wired or wireless communication interface. Although sensors 252 and vehicle systems 258 are depicted as communicating with machine learning circuit 210, they can also communicate with each other as well as with other vehicle systems. machine learning circuit 210 can be implemented as an ECU or as part of an ECU such as, for example electronic control unit 150. In other embodiments, machine learning circuit 210 can be implemented independently of the ECU.

Machine learning circuit 210 in this example includes a communication circuit 201, a decision circuit 203 (including a processor 206 and memory 208 in this example) and a power supply 212. Components of machine learning circuit 210 are illustrated as communicating with each other via a data bus, although other communication in interfaces can be included. Machine learning circuit 210 in this example also includes distributed machine learning client 205 that can be operated to connect to an edge device (e.g., an MED) or cloud-based server of a network 290 to contribute to training models and/or download models for training by machine learning circuit 210 and/or for use by vehicle systems 258 in operating the vehicle. For example, distributed machine learning client 205 may be executed to download a model via communication circuit 201 and train the model locally on the vehicle using training data stored on the vehicle. The training data may comprise vehicle data collected by sensors 252 and/or vehicle systems 258, as well as other data provided to the vehicle (e.g., from other vehicles or external devices). In some examples the downloaded model can be utilized by vehicle systems 258 to control operations of the vehicle to accomplish vehicle tasks according to the model. The distributed machine learning client 205 may be executed to share the locally trained model with the edge server and/or another vehicle.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store instructions and variables for processor 206 as well as any other suitable information, such as, one or more of the following elements: vehicle data; training data sets; and historical energy consumption information, along with other data as needed. Memory 208 can be made up of one or more modules of one or more different types of memory, and may be configured to store data and other information as well as operational instructions that may be used by the processor 206 to machine learning circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a machine learning circuit 210.

Communication circuit 201 includes either or both a wireless transceiver circuit 202 with an associated antenna 214 and a wired I/O interface 204 with an associated hardwired data port (not illustrated). Communication circuit 201 can provide for vehicle-to-everything (V2X) and/or vehicle-to-vehicle (V2V) communications capabilities, allowing machine learning circuit 210 to communicate with edge devices, such as roadside unit/equipment (RSU/RSE), network cloud servers and cloud-based databases, and/or other vehicles via network 290. For example, V2X communication capabilities allows machine learning circuit 210 to communicate with cloud servers, roadside infrastructure (e.g., such as roadside equipment/roadside unit, which may be a vehicle-to-infrastructure (V2I)-enabled street light or cameras, for example), other edge devices, etc. Machine learning circuit 210 may also communicate with other connected vehicles over vehicle-to-vehicle (V2V) communications.

As this example illustrates, communications with machine learning circuit 210 can include either or both wired and wireless communications circuits 201. Wireless transceiver circuit 202 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by machine learning circuit 210 to/from other entities such as sensors 252 and vehicle systems 258.

Wired I/O interface 204 can include a transmitter and a receiver (not shown) for hardwired communications with other devices. For example, wired I/O interface 204 can provide a hardwired interface to other components, including sensors 252 and vehicle systems 258. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 252 can include, for example, sensors 152 such as those described above with reference to the example of FIG. 1. Sensors 252 can include additional sensors that may or may not otherwise be included on a standard vehicle with which the distributed machine learning system 200 is implemented. In the illustrated example, sensors 252 include vehicle acceleration sensors 218, vehicle speed sensors 220, SOC sensors 222 to detect a state of charge of batteries on the vehicle, environmental sensors 224 (e.g., to detect salinity or other environmental conditions), and proximity sensor 226 (e.g., sonar, radar, lidar or other vehicle proximity sensors). Additional sensors 230 can also be included as may be appropriate for a given implementation of distributed machine learning system 200.

System 200 may be equipped with one or more image sensors 228. These may include front facing image sensors, side facing image sensors, and/or rear facing image sensors. Image sensors may capture information which may be used in detecting not only vehicle conditions but also detecting conditions external to the vehicle as well. Image sensors that might be used to detect external conditions can include, for example, cameras or other image sensors configured to capture data in the form of sequential image frames forming a video in the visible spectrum, near infra-red (IR) spectrum, IR spectrum, ultra violet spectrum, etc. Image sensors 228 can be used to, for example, to detect objects in an environment surrounding a vehicle comprising distributed machine learning system 200, for example, surrounding vehicles, RSE/RSU, roadway environment, road lanes, road curvature, obstacles, and so on. For example, a one or more image sensors 228 may capture images of surrounding vehicles in the surrounding environment. As another example, object detecting and recognition techniques may be used to detect objects and environmental conditions, such as, but not limited to, road conditions, surrounding vehicle behavior (e.g., driving behavior and the like), and the like. Additionally, sensors may estimate proximity between vehicles. For instance, the image sensors 228 may include cameras that may be used with and/or integrated with other proximity sensors 230 such as LIDAR sensors or any other sensors capable of capturing a distance. As used herein, a sensor set of a vehicle may refer to sensors 252.

Vehicle systems 258, for example, systems and subsystems 158 described above with reference to the example of FIG. 1, can include any of a number of different vehicle components or subsystems used to control or monitor various aspects of the vehicle and its performance. In this example, the vehicle systems 258 includes a vehicle positioning system 272; engine control circuits 276 to control the operation of engine (e.g. internal combustion engine 114 and/or motors 122); object detection system 278 to perform image processing such as object recognition and detection on images from image sensors 228, proximity estimation, for example, from image sensors 228 and/or proximity sensors, etc. for use in other vehicle systems; battery systems 274 (e.g., systems that can be implemented to control operation of power supply 212 or other electrical power storage devices included in the vehicle that can provide electrical power for achieving vehicle tasks), and other vehicle systems 282 (e.g., Advanced Driver-Assistance Systems (ADAS), autonomous or semi-autonomous driving systems 280, such as forward/rear collision detection and warning systems, pedestrian detection systems, autonomous or semi-autonomous driving systems, and the like).

Autonomous or semi-autonomous driving systems 280 can be operatively connected to the various vehicle systems 258 and/or individual components thereof. For example, autonomous or semi-autonomous driving systems 280 can send and/or receive information from the various vehicle systems 258 to control the movement, speed, maneuvering, heading, direction, etc. of the vehicle. The autonomous or semi-autonomous driving systems 280 may control some or all of these vehicle systems 258 and, thus, may be semi- or fully autonomous. Autonomous or semi-autonomous driving systems 280 can be configured to utilize a model to control operations of the vehicle in accomplishing vehicle tasks.

Network 290 may be a conventional type of network, wired or wireless, and may have numerous different configurations including a star configuration, token ring configuration, or other configurations. Furthermore, the network 290 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 290 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VOLTE, 5G-V2X or any other mobile data network or combination of mobile data networks. Further, the network 290 may include one or more IEEE 802.11 wireless networks.

In some embodiments, the network 290 includes a V2X network (e.g., a V2X wireless network). The V2X network is a communication network that enables entities such as elements of the operating environment to wirelessly communicate with one another via one or more of the following: Wi-Fi; cellular communication including 3G, 4G, LTE, 5G, etc.; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs) and Personal Safety Messages (PSMs), among other types of DSRC communication); Long-Term Evolution (LTE); millimeter wave (mmWave) communication; 3G; 4G; 5G; LTE-V2X; 5G-V2X; LTE-Vehicle-to-Vehicle (LTE-V2V); LTE-Device-to-Device (LTE-D2D); Voice over LTE (VOLTE); etc. In some examples, the V2X communications can include V2V communications, Vehicle-to-Infrastructure (V2I) communications, Vehicle-to-Network (V2N) communications or any combination thereof.

Examples of a wireless message (e.g., a V2X wireless messages, V2V wireless messages, and/or V21 wireless messages) described herein include, but are not limited to, the following messages: a Dedicated Short Range Communication (DSRC) message; a Basic Safety Message (BSM); a Long-Term Evolution (LTE) message; an LTE-V2X message (e.g., an LTE-Vehicle-to-Vehicle (LTE-V2V) message, an LTE-Vehicle-to-Infrastructure (LTE-V2I) message, an LTE-V2N message, etc.); a 5G-V2X message; and a millimeter wave message, etc.

During operation, machine learning circuit 210 can receive information from various vehicle sensors to be committed to memory 208 as vehicle data. The vehicle data, in some examples, may be used for training a machine learning model, in which case the vehicle data may be referred to as training data. Communication circuit 201 can be used to transmit and receive information between machine learning circuit 210 and sensors 252, and machine learning circuit 210 and vehicle systems 258. Also, sensors 252 may communicate with vehicle systems 258 directly or indirectly (e.g., via communication circuit 201 or otherwise).

As another example, machine learning circuit 210 can receive information from other connected vehicles, edge devices, or other external devices via wireless messages, which can be committed to memory and used as training data. In this example, communication circuit 201 can be used to receive the information via wireless messages through V2V, V2I, and/or V2X communications and transmit the information to machine learning circuit 210 for storage in memory 208.

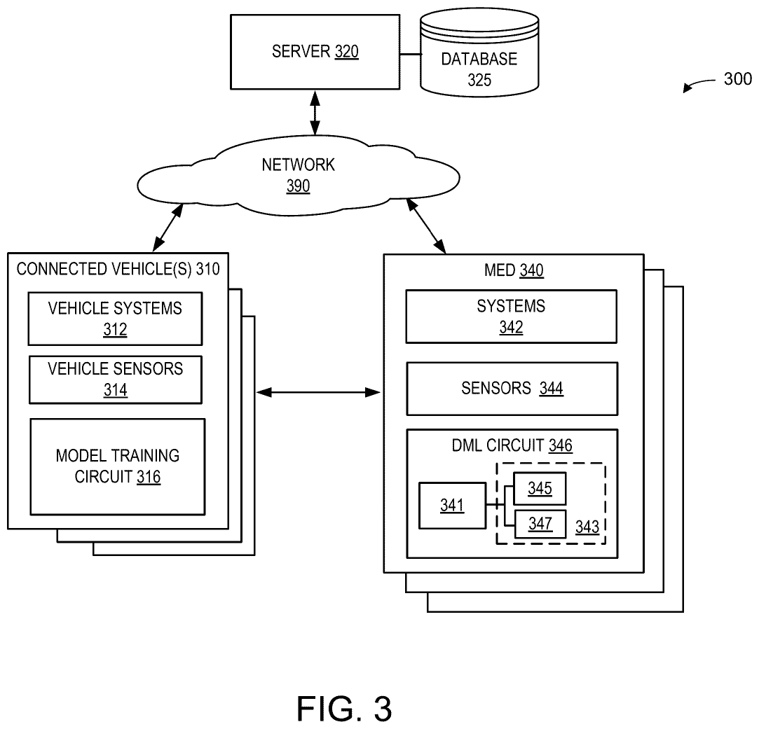

FIG. 3 is an example architecture of an example vehicular disturbed machine learning system 300 in accordance with various embodiments disclosed herein. The system 300 includes one or more connected vehicles 310 (collectively referred to as connected vehicles or vehicle 310) and one or more mobile edge devices (MED) 340. The MED 340 may be implemented, for example, as a roadside equipment/unit (RSE/RSU) or other device of a roadside infrastructure. The connected vehicles 310 and MED 340 can all communicate with one another in this example, directly (e.g., via V2V and/or V2I communications) or through network 390. For example, connected vehicles 310 can communicate with other connected vehicles 310, and each connected vehicle can communicate with the MED 340. Network 390 may be an example implementation of network 290 of FIG. 2.

In some examples, as shown in FIG. 3, system 300 may also comprise a server 320 and a database 325, which may be cloud-based server and cloud-based database. The connected vehicles 310 and/or MED 340 can communicate with server 320 through network 390. For example, connected vehicles 310 can communicate with other connected vehicles 310, and each connected vehicle can communicate with the MED 340.

Connected vehicles 310 may be, for example, implemented as vehicle 100 of FIG. 1 or other type of vehicle. Connected vehicles 310 comprises vehicle systems 312 and vehicle sensors 314 that are substantially similar to vehicle systems 258 and sensors 252 of FIG. 2. Connected vehicles 310 also includes machine learning circuit 316 (sometimes referred to herein as a computing device), which may be substantially similar to machine learning circuit 210 of FIG. 2. As such, each connected vehicle 310 may each provide similar functionality.

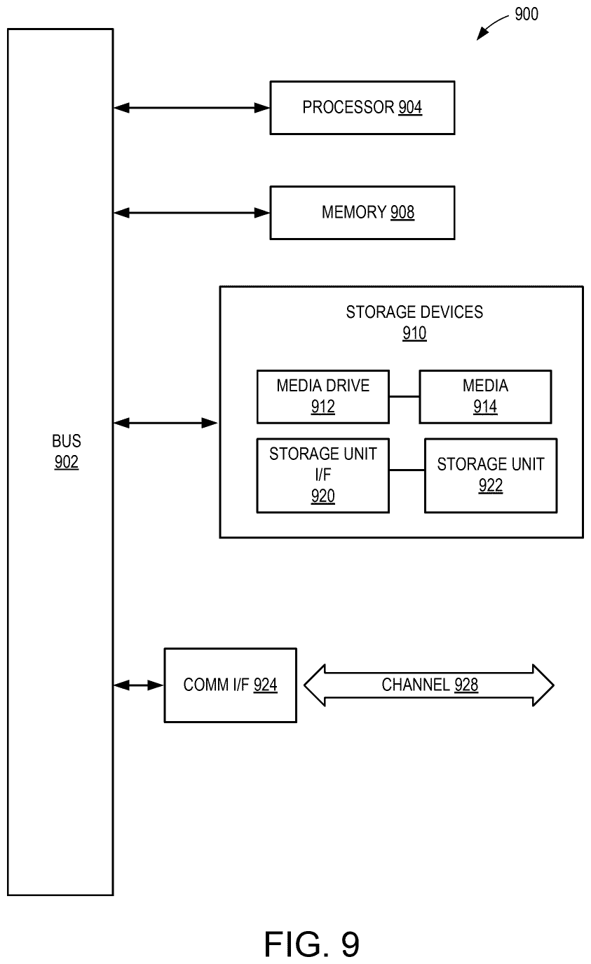

The MED 340 includes an distributed machine learning circuit 346 (sometimes referred to herein as a computing device), systems 342, and sensors 344. The MED 340 can be implemented, for example, as a computing component, such as computing component 900 of FIG. 9. The sensors 344 may be similar to sensors 252, for example, comprising environmental sensors 228 (e.g., to detect salinity and/or other environmental conditions), proximity sensor 230 (e.g., sonar, radar, lidar and/or other vehicle proximity sensors), and image sensors 228 and the like for capturing data of an environment surrounding the MED 340. Systems 342 may include, for example, object detection system 278 to perform image processing such as object recognition and detection on images from image sensors 260, proximity estimation, for example, from image sensors 228 and/or proximity sensors, etc.

The distributed machine learning circuit 346 in this example includes a communication circuit 341, a decision circuit 343 (including a processor 347 and memory 345 in this example). Components of distributed machine learning circuit 346 are illustrated as communicating with each other via a data bus, although other communication in interfaces can be included. distributed machine learning circuit 346 can be operated to connect to connected vehicle 310 directly or through network 290 to transmit models for training by connected vehicles 310 and/or downloading models trained locally at connected vehicles 310.

Processor 347 can include one or more GPUs, CPUs, microprocessors, or any other suitable processing system. Processor 347 may include a single core or multicore processors. The memory 345 may include one or more various forms of memory or data storage (e.g., flash, RAM, etc.) that may be used to store instructions and variables for processor 347 as well as any other suitable information, such as, one or more of the following elements: models parameters; training data sets; and test data sets, along with other data as needed. Memory 345 can be made up of one or more modules of one or more different types of memory, and may be configured to store data and other information as well as operational instructions that may be used by the processor 347 to distributed machine learning circuit 346.

Although the example of FIG. 3 is illustrated using processor and memory circuitry, as described below with reference to circuits disclosed herein, decision circuit 343 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a distributed machine learning circuit 346.

Communication circuit 341 includes a wireless transceiver circuit with an associated antenna, for example, substantially as shown in FIG. 2. Communication circuit 341 can provide for V2X and/or V2I communications capabilities, allowing distributed machine learning circuit 346 to communicate with connected vehicles 310 and server 320. For example, V2X communication capabilities allows distributed machine learning circuit 346 to communicate with cloud servers, other roadside infrastructure (e.g., such as roadside equipment/roadside unit, which may be a vehicle-to-infrastructure (V2I)-enabled street light or cameras, for example), other edge devices, etc. Whereas, distributed machine learning circuit 346 may also communicate with connected vehicles 310 over V2V communications.

As this example illustrates, communications with distributed machine learning circuit 346 can include wireless communications circuits 341. Communications circuit 341 can include a transmitter and a receiver to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. An antenna can be coupled to a wireless transceiver circuit and used by wireless transceiver circuit to transmit radio signals wirelessly to wireless equipment with which it is connected and to receive radio signals as well. These RF signals can include information of almost any sort that is sent or received by distributed machine learning circuit 346 to/from other devices in system 300.

In examples disclosed herein, system 300 may be implemented for distributed machine learning. For example, system 300 can be implemented as a fully federated distributed machine learning architecture in which the MEDs 340 communicate directly with connected vehicles 310 via wireless messages. Each connected vehicle 310 may store its own training data locally on-board (e.g., in memory) and receive machine learning models (including model parameters) packaged into a wireless message from the MED 340. Each connected vehicle 310 may train a model locally on-board via its respective machine learning circuit 316, and communicate the trained model back to the MED 340. Each MED 340 can aggregate the trained models from the connected vehicles or provide to server 320 for aggregation.

In another example, system 300 can be implemented as a fully decentralized distributed machine learning architecture. In this case, a connected vehicle 310 trains a model using its locally stored training data. The machine learning model (including model parameters) of the trained model can packaged into a wireless message and communicated to remote connected vehicle 310 via V2V communications for training locally at the other connected vehicle 310. The exchanging of the trained models between connected vehicles provides for aggregating the models at each vehicle.

System 300 can also be implemented as a hybrid distributed machine learning architecture. In this case, an MED 340 communicates directly with a connected vehicle 310 to provide a machine learning model using a wireless message. The connected vehicle 310 then trains the model using its locally stored training data and provides model parameters of the trained model to a next connected vehicle 310 remote from the first connected vehicle. This next connected vehicle 310 trains the model by applying its training data to the model parameters. The process is repeated for a number of connected vehicles 310, and the final connected vehicle transmits the model parameters of the trained model back to the MED 340.

As noted above, the machine learning models can be packaged into wireless messages, such as those described in connection with FIG. 2. As used herein, wireless messages that contain machine learning models and model parameters, according to the examples disclosed herein, may be referred to as distributed machine learning (DML) messages.

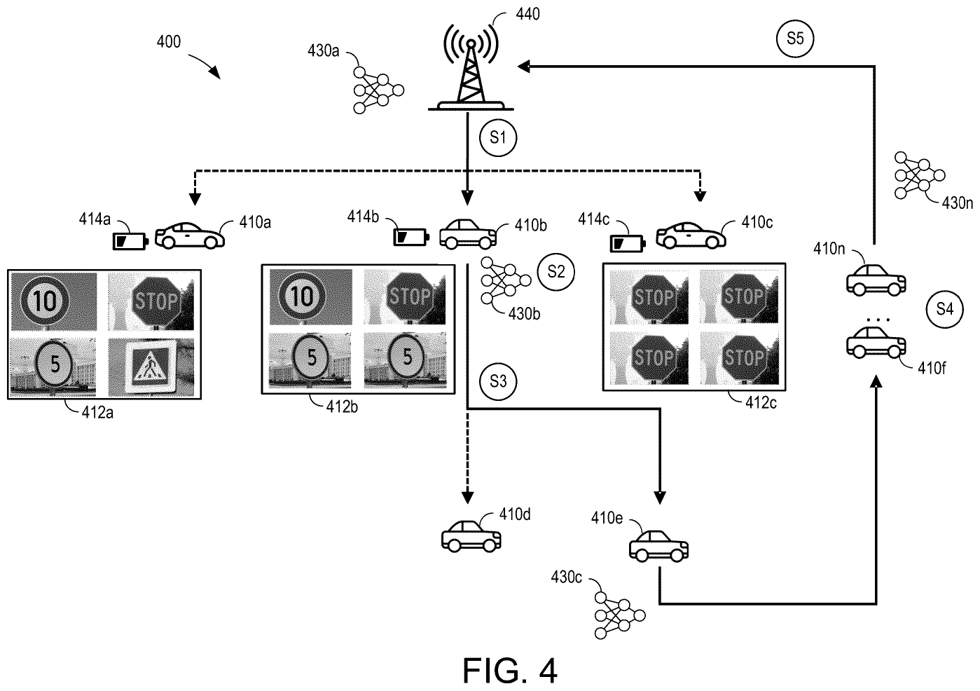

FIG. 4 is a flow illustrating example operations performed by an example vehicular distributed machine learning system 400 in accordance with embodiments disclosed herein. System 400 comprises a MED 440 connected to a plurality of connected vehicles 410a-410n directly via V2I communications or through a network (e.g., network 290 and/or network 390). MED 440 may be substantially similar to MED 340 of FIG. 3 and each connected vehicle 410a-410n may be substantially similar to connected vehicle 310 of FIG. 3.

According to various embodiments, the MED 340 comprise memory storing a machine learning model 430a. Machine learning model 430a may be configured to control operations of a vehicle to accomplish vehicle tasks according to the training of the machine learning model. Machine learning model 430a can comprise an algorithm. Training the machine learning model 430a may include applying training data to the algorithm, whereby the machine learning model 430a learns and assigns numerical values (“weights”) to generate a trained machine learning model. Model parameters may define certain aspects of the trained model.

Embodiments disclose herein provide for a vehicular distributed machine learning architecture that enables high performance model training with reduced energy consumption. Examples disclosed herein utilize a model training metric, associated with each connected vehicle 410a-410n, to select a vehicle for training the machine learning model. The model training metric provides for a balancing between training performance and energy consumed to train the model.

In an example, at operation S1, MED 440 performs initial client selection to select an initial client, from a set of clients, to training the machine learning model 430a in an initial training stage. For example, MED 440 selects an initial client (e.g., a connected vehicle) from the set of clients (e.g., a first set of connected vehicles 410a-410c) based on model training metrics associated with the set of clients. Each connected vehicle 410a-410c may share information indicative of its respective model training metric with the MED 440 using wireless messages directly via V2I communications or indirectly over a network. In some examples, each model training metric can be determined locally on a respective connected vehicle 410a-410c and shared with the MED 440. In another example, each connected vehicle 410a-410c may share information from which the MED 440 can derive the model training metric. According to various examples, the MED 440 identifies the largest model training metric from those received and selects the connected vehicle associated with the identified model training metric. MED 440 can then transmit the machine learning model 430a to the selected connected vehicle for training.

In more detail, MED 440 may identify a number of connected vehicles that are within a communication range of the MED 440. For example, MED 440 may use V2I communications to communicate with connected vehicles, which has a defined range that is based on the capabilities of the communication interface (e.g., Bluetooth, near field communications (NFC), Zigbee, etc.). In the example of FIG. 4, MED 440 may detect connected vehicles 410a-410c as being within the communication range of the MED 440 and able to connect to the MED 440 and identify them as candidate clients. While three connected vehicles 410a-410c are shown in FIG. 4, more or fewer connected vehicles may be identified, for example, one connected vehicle or any number of connected vehicles.

Each connected vehicle 410a-410c can be associated with a model training metric computed from information locally held by the respective connected vehicle. Each model training metrics may be based on a measure of diversity in training data stored at a respective connected vehicle and an estimate of energy that the respective vehicle may consume to train the machine learning model 430a on the respective training data. In various examples, each model training metric may be provided as a ratio of the measure of the diversity to the estimate of energy to be consumed.

As alluded to above, each connected vehicle 410a-410c may store a respective training data set 412a-412c locally (e.g., in memory 208). The training data sets 412a-412c may be any data type that can be applied to a machine learning model for training the model. The training data may be obtained as vehicle data from sensors and/or vehicle systems (e.g., sensors 252 and/or vehicle systems 258), as well as vehicle data communicated to a respective connected vehicle from other connected vehicles (e.g., via V2V communication).

In the example of FIG. 4, the training data sets contain images of road signs for training a machine learning model to recognize road signs from an environment surrounding a vehicle. The training data sets 414a-414c may have varying levels of diversity across the distribution of a given training data set. For example, as shown in FIG. 4, training data set 412c has a low level of diversity because each image contains an image of the same or similar road sign (e.g., a stop sign), training data set 412a has a high level of diversity as each image depicts a different road sign, and training data set 412b has a middle level of diversity as some images depict the same sign and others are different. In this case, a machine learning model trained using training data set 412a may generate a model having a high performance in an ability to accurately detect numerous road signs, but at the expense of energy consumed in training (e.g., training a model on an epoch of training data set 412a may consume larger amounts of energy). Whereas, a machine learning model trained using training data set 412c may consume less energy per epoch of training, but generate a trained model having a low performance due to lack of diversity in the training data.

In various examples disclosed herein, diversity in training data can be measured, for example, using the concept of entropy. As an illustrative example, the diversity can be measured using Shannon Entropy as follows:

$$\sum P ( {x}_{i} ) log P ( {x}_{i} ) \qquad Eq . 1$$

where xᵢ represents the i^{th} image of a training data set and P (xᵢ) represents a probability distribution outcome for the i^{th} image. While an image dataset are described herein, the disclosed embodiments are not limited to images. The embodiments disclosed herein can be applied to datasets of any type of data.

While examples disclosed herein utilize Shannon Entropy, other measures of diversity across a training set may be utilized. For example, embodiments disclosed herein may provide a measure of the diversity as, but not limited to, a Jaccard distance or Kullback-Leibler divergence, among others.

Each connected vehicle 410a-410c may also store respective energy consumption data 414a-414c. The energy consumption data may be an estimate of consumed (etrain) by the vehicle to training a machine learning model on epoch of a respective training data set. For example, energy consumption data 414a may represent an estimate of energy that connected vehicle 410a may consume to train machine learning model 430a using training data set 412a. Likewise, energy consumption data 414b and 414c may represent estimates of energy that may be consumed by connected vehicles 410b and 410c, respectively, to train machine learning model 430a using their respective training data sets 412b and 412c.

The estimate of energy consumed may be based on historical energy consumption information obtained from prior training sessions of the same or different models using the training data set. For example, connected vehicle 410a may have previously trained a machine learning model using training data set 412a, which consumed a certain amount of energy per epoch of training data in the set. The connected vehicle 410a may measure the amount of energy consumed using, for example, an SOC sensor (e.g., SOC sensors 222 or the like). Each time the vehicle trains a model, the energy consumed can be measured to build historical energy consumption information.

In various examples, eₜᵣₐᵢₙ may be based on an average of historical energy consumed for a number of historical training instances. In an illustrative example, eₜᵣₐᵢₙ can be determined using a rolling average of the historical energy consumed as follows:

$${e}_{train , t + 1} = \frac{{e}_{train , t - 1} + {e}_{train , t}}{2} \qquad Eq . 2$$

where e_{train,t+1} represents an estimate of energy that may be consumed for a next instance of training, e_{train,t} represents a measure of energy consumed at a most recent instance t during which a respective vehicle trained a model, and e_{train,t-1} represents a measure of energy consumed at a preceding instance t during which a respective vehicle trained a model. e_{train,t+1} may represent an updated estimate of eₜᵣₐᵢₙ. While the above example uses a window size of two instances, some examples may use larger window sizes (e.g., 3, 4, 5, etc. instances of training). While an averaging technique is described herein, embodiments may alternatively use a static or fixed value for eₜᵣₐᵢₙ, which may be empirically set.

In a case where historical energy consumption information is not available, eₜᵣₐᵢₙ may be set as a preset value. For example, a vehicle may not have performed any prior training or may not have access to historical information. In this case, a factory-default value for eₜᵣₐᵢₙ may have been stored in memory, which can be used as a eₜᵣₐᵢₙ in the first instance and/or as e_{train,t-1} in a later instance. The value may be determined by measurement of energy consumed during manufacture of the vehicle.

In an illustrative example, a model training metric (B) can be provided as:

$$B ( {X}_{C} ) = \frac{\sum P ( {x}_{i} ) log P ( {x}_{i} )}{{e}_{train}} \qquad Eq . 3$$

where X_{C} represents a given training data set consisting of an i number of data x. In some examples, e_{train,t+1} from Eq. 2 may be set as eₜᵣₐᵢₙ. Updating eₜᵣₐᵢₙ over time can improve the accuracy of client selection since it provides up-to-date information for computing the model training metric. Furthermore, as the size and variety of training data stored on a given vehicle grows or changes over time, eₜᵣₐᵢₙ will also change accordingly.

As noted above, each connected vehicle 410a-410c can compute its own model training metric (B(X_{C})) using its respective training data set and energy consumption data. Each connected vehicle 410a-410c can periodically compute an updated value for it model training metric (B(X_{C})) to provide an update-to-date metric in real-time. In some examples, instead of computing a model training metric, each connected vehicle 410a-410c may share its measure of diversity (e.g., Shannon Entropy) and estimate of energy consumed to the MED 440 and/or other connected vehicles, which can use the information to compute a model training metric for the transmitting vehicle.

As noted above, at operation S1, MED 440 obtains model training metrics for each connected vehicle within range of the MED 440 and selects an initial client that has the largest model training metric. In the example of FIG. 4, MED 440 selects connected vehicle 410b because its model training metric (B(X_{C})) is larger than that of connected vehicles 410a and 410c. For examples, energy consumption data 414a may be 60 mW, energy consumption data 414b may be 40 mW, and energy consumption data 414c may be 10 mW. But, as noted above, the diversity of training data set 412c is low resulting in low model training performance, while the diversity of training data set 412a is high resulting in high model training performance. However, due to the ratio in Eq. 3, the model training met metric (B(X_{C})) for connected vehicle 410b may optimally balance the tradeoff between performance and energy.

The MED 440 packages the machine learning model 430a into a distributed machine learning message and transmits the message to connected vehicle 410b as the initial client.

At operation S2, connected vehicle 410b trains the machine learning model 430a during an initial stage of training using training data set 412b. For example, using a machine learning circuit (e.g., machine learning circuit 210 of FIG. 2 and/or machine learning circuit 316 of FIG. 3) to generate an updated machine learning model 430b. Connected vehicle 410b measures the amount of energy consumed in training the machine learning model 430a to generate updated machine learning model 430b and stores the measured energy consumed as an updated measure (e.g., e_{train,t}) for updating its model training metric (B(X_{C})).

At operation S3, the connected vehicle 410b performs client selection for a next stage of distributed machine learning based on model training metrics associated with nearby remote connected vehicles. Connected vehicle 410b may detect a number of connected vehicles that are within communication range of the connected vehicle 410b. For example, connected vehicle 410b may use V2V communications to communicate with nearby vehicles, which has a defined range based on the capabilities of the communication interface (e.g., communication circuit 201 of FIG. 2). In the example of FIG. 4, connected vehicle 410b may detect connected vehicles 410d-410e are within the defined range of the connected vehicle 410b and able to connect thereto. Upon detecting the connected vehicles 410d-410e, connected vehicle 410b may identify the detected connected vehicles as candidate clients for training the machine learning model 430b.

While two connected vehicles 410d-410e are shown in FIG. 4, more or fewer connected vehicles may be identified, for example, one connected vehicle or any number of connected vehicles. Furthermore, the connected vehicles identified by connected vehicle 410b may include one or more of the connected vehicles identified by MED 440 (e.g., connected vehicles identified by connected vehicle 410b may include connected vehicle 410a and/or connected vehicles 410c).

In various examples, connected vehicle 410b may then obtain information indicative of model training metrics from the candidate clients. For example, as described above, connected vehicles 410d and 410e may determine respective model training metrics that balance diversity in respective training data sets and an estimate of energy consumed to train the machine learning model 430b. More particularly, in various examples, connected vehicles 410d and 410e may each determine a model training metric according to Eq. 3 above. In another example, connected vehicle 410b may obtain a measure of diversity of locally training data sets and an estimate of energy consumed from each candidate client and compute the respective model training metrics at the connected vehicle 410b.

Based on the obtained model training metrics, connected vehicle 410b can select a candidate client for refining the machine learning model 430b. Connected vehicle 410b can package the machine learning model 430b into a distributed machine learning message and transmit the message to the selected candidate client. For example, as shown in FIG. 4, connected vehicle 410b may determine that the model training metrics for connected vehicle 410e is larger than that of connected vehicle 410d. Responsive to this determination, connected vehicle 410b transmits the machine learning model 430b to connected vehicle 410e using a distributed machine learning message.

Connected vehicle 410e can then refine the machine learning model 430b locally using its training data set. For example, connected vehicle 410e trains the machine learning model 430b at a second stage of training by applying its own training data set to the model, for example, using a machine learning circuit (e.g., machine learning circuit 210 of FIG. 2 and/or machine learning circuit 316 of FIG. 3) to generate updated machine learning model 430c. Connected vehicle 410e measures the amount of energy consumed in training the machine learning model 430b to generate updated machine learning model 430c and stores the measured energy consumed as an updated measure (e.g., e_{train,t}) for updating its model training metric (B(X_{C})).

At operation S4, operations of S3 are repeated in a number of instances for a number n of training stages, where each transfer of a trained model may be considered a hop. For example, each selected client (e.g., connected vehicle 410e) of a current training stage selects a next client for further refining the machine learning model based on model training metrics associated with the selected client and any other connected vehicles identified as candidate clients. As an illustrative example, connected vehicle 410e may select connected vehicle 410f for training based on a model training metrics associated with connected vehicle 410f compared to other candidate clients (not shown) identified by connected vehicle 410e. Connected vehicle 410e transmits machine learning model 430c to connected vehicle 410f, which executes a next stage of training that further refines the machine learning model. Connected vehicle 410f outputs an updated machine learning model which can be provided to next connected vehicle for further refinement, and so on.

At operation S5, the distributed machine learning may be complete and connected vehicle 410n, as the final client for refining the machine learning model, transmits trained machine learning model 430n to the MED 440. For example, connected vehicle 410n may have trained a machine learning model from a preceding connected vehicle to generate machine learning model 430n, and the machine learning model 430n can be packaged into a distributed machine learning message that is to MED 440 via V2I communications. MED 440 may then deploy the updated machine learning model 430n to connected vehicles for use by vehicle systems (e.g., vehicle systems 258) in executing vehicle tasks. In another example, the process shown in FIG. 4 may be repeated to further refine the model.

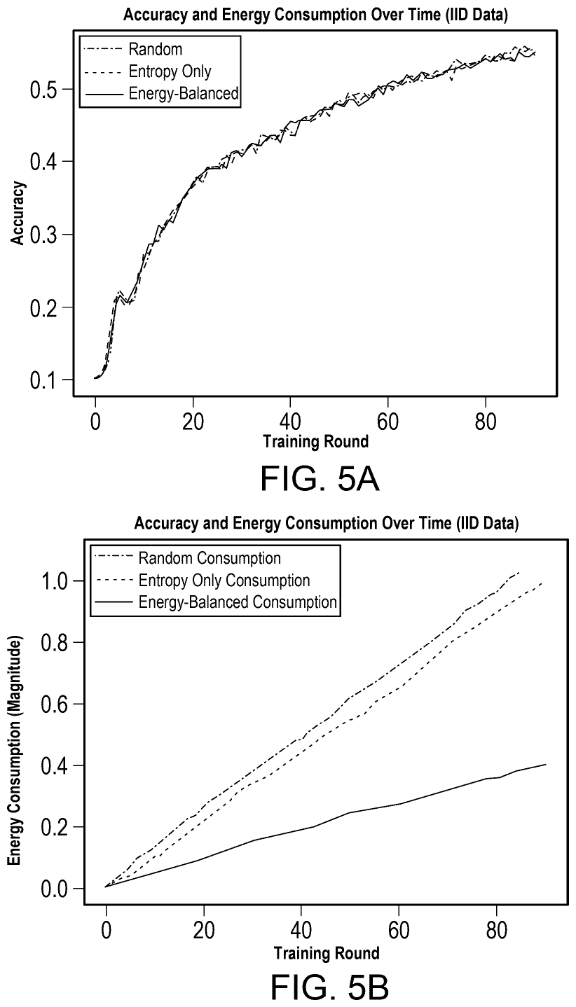

FIGS. 5A and 5B depict simulation results of distributed machine learning according to the present disclosure compared to conventional systems. The simulations used to provide FIGS. 5A and 5B were performed with training data distributed to clients in a simulated vehicular network, where the training data was IID data. FIG. 5A depicts accuracy (y-axis) as a function of number of training rounds of a machine learning model for: (a) a random client selection technique (referred to as random selection); (b) a client selection technique that selects next clients using entropy only (referred to as entropy selection); and (c) a selection technique according to the present disclosure (referred to as energy-balanced selection). FIG. 5B depicts energy consumption (y-axis) as a function of number of training rounds of a machine learning model for: (a) random selection; (b) entropy selection; and (c) energy-balanced selection. The number of training rounds reflects a total of training across the distributed machine learning model.

As shown in FIGS. 5A and 5B the embodiments of the present disclosure (e.g., energy-balanced consumption line) provides for approximately a 63% improvement over random client selection techniques and a 60% improvement over techniques that selects clients using entropy only. FIGS. 5A and 5B illustrate that a rate of increase in total energy consumption for embodiments disclosed herein is lower than existing approaches, without a detriment to the accuracy of the global model over time.

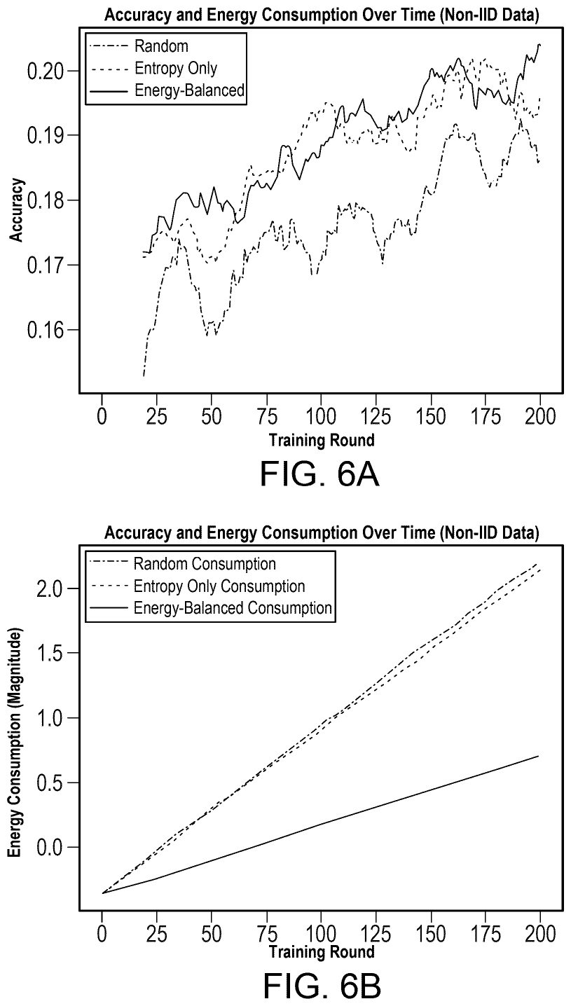

FIGS. 6A and 6B depict other simulation results of distributed machine learning according to the present disclosure compared to conventional systems. The simulations used to provide FIGS. 6A and 6B were performed with training data distributed to clients in a simulated vehicular network, where the training data was non-IID data. FIG. 6A depicts accuracy (y-axis) as a function of number of training rounds of a machine learning model for: (a) random selection; (b) entropy selection; and (c) energy-balanced selection according to the embodiments disclosed herein. FIG. 6B depicts energy consumption (y-axis) as a function of number of training rounds of a machine learning model for: (a) random selection; (b) entropy selection; and (c) energy-balanced selection.

As shown in FIGS. 6A and 6B, the embodiment disclosed herein provide improved energy consumption compared to conventional approaches. For example, embodiments disclosed herein are 60% more efficient than random and 58% more efficient than entropy only selection. Thus, aggregate energy consumption over time of the embodiment disclosed herein is lower, while maintaining comparable model performance to entropy only selection and improved performance over random selection.

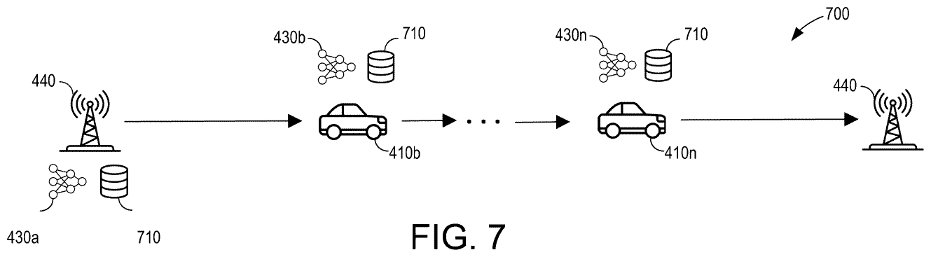

FIG. 7 is flow illustrating example stoppage conditions, according to embodiments disclosed herein, for the example vehicular distributed machine learning system 400. FIG. 7 includes MED 440 connected to connected vehicles 410a-410n as described above in connection with FIG. 4. As described above, MED 440 and/or connected vehicles 410a-410n select clients for training based on model training metrics associated with the connected vehicles and transmit the machine learning model downstream via a distributed machine learning message, as deceived above. Each transmission of the machine learning model to a downstream connected vehicle may be referred to herein as a “hop.”

In the example of FIG. 7, each distributed machine learning message may also include completion information 710. The completion information 710 can be used by a receiving client to determine if the distributed machine learning is complete or not and, based on the determination, transmit a trained machine learning model to the MED 440. The completion information 710 may include completion criteria that define conditions that once met are indicative that the training is complete. The completion information 710 may also include a completion tracking information that can be utilized by clients to derive, using on-board systems, current conditions of the training. A client can compare the current conditions with the completion criteria to determine if the completion criteria are satisfied or not. If satisfied, the client can transmit the most recent update machine learning model to the MED 440.

As an illustrative example, MED 440 may select connected vehicle 410b as an initial client, as described above in connection with FIG. 4. MED 440 can transmit a distributed machine learning message that includes the completion information 710, along with the machine learning model 430a. Connected vehicle 410b may access completion information 710 to obtain the completion criteria and completion tracking information. After generating machine learning model 430b, connected vehicle 410b may determine current conditions of the training based on the completion tracking information and compare the current conditions to the completion criteria. Connected vehicle 410b may determine that the current conditions do not satisfy the completion criteria and perform client selection, as described above in connection with FIG. 4. Connected vehicle 410b updates the completion information 710 and packages its machine learning model 430b with completion information 710 as a distributed machine learning message, which is provided to the selected client.

Subsequently, connected vehicle 410n may be selected as a client for training, either by connected vehicle 410b or another intermediate client. In this example, connected vehicle 410n receives a distributed machine learning message that includes a machine learning model and completion information 710. Connected vehicle 410n may obtain the completion criteria and completion tracking information from completion information 710. After generating machine learning model 430n, connected vehicle 410n may determine that current conditions, determined locally at connected vehicle 410n based on the completion tracking information, satisfy the completion criteria. Responsive to this determination, connected vehicle 410n communicates the updated machine learning model 430n to MED 440 to complete the distributed machine learning.

Embodiments disclosed herein, in some examples, may utilize a fixed hop stoppage condition, in which the completion criteria may comprise a number of training stages to be performed, which defines a fixed number of hops. For example, completion information 710 may comprise information indicating that a number of n training stages to be performed by a number of n clients, where n is an integer. Once the n number of training stages are complete, the final client transmits its trained machine learning model to MED 440.

In this example, completion tracking information may include a counter that can be incremented by each client after training. With reference to the above example, connected vehicle 410b accesses the counter contained in completion information 710 and, after generating machine learning model 430b, updates the counter by incrementing the counter by one. As connected vehicle 410b is the initial client, the counter may be incremented from zero to one. In this case, the completion criteria may be, for example, 3 training stages (e.g., n=3). Connected vehicle 410b may obtain the completion criteria and compare it to the updated counter. Connected vehicle 410b can determine that the counter is less than three and that the completion criteria is not satisfied. Connected vehicle 410b may then transmit machine learning model 430b and completion information 710 to a next client to perform a second stage of training and increment the counter to two.

Presume that connected vehicle 410n receives a distributed machine learning message from the next client and performs a third stage of training to generate updated machine learning model 430n. Connected vehicle 410n may access the counter contained in completion information 710 and, after generating machine learning model 430n, updates the counter by incrementing the counter to three. In this case, connected vehicle 410n may obtain the completion criteria and compare it to the updated counter to determine that the counter is equal to three. Thus, connected vehicle 410n can determine the completion criteria is satisfied and provide the updated machine learning model 430n to MED 440.

Embodiments disclosed herein, in another example, may utilize an adaptive hop stoppage condition, in which the completion criteria may comprise a performance threshold for the machine learning model. The performance threshold may be updated after each training stage, thereby enabling execution of an adaptable number of hops to improve model performance.

In this case, completion tracking information may include information that can be used to determine the performance of a trained machine learning model. For example, completion tracking information may include a test data set that can be applied to a machine learning model and used to verify the performance of the model from results. In the example of FIG. 7, each connected vehicle may measure the performance of it respectively trained machine learning model using its on-board computing device (e.g., machine learning circuit 210 and/or machine learning circuit 316). The measured performance can be compared to the performance threshold and, if the measured performance is equal to or exceeds the performance threshold, the trained machine learning model can be transmitted to the MED 440.

In an illustrative example, completion criteria may be an accuracy threshold for the machine learning model (e.g., machine learning model 430a). In an example implementation, the accuracy threshold may be provided as:

$$τ = \frac{α}{n} \qquad Eq . 4$$

where α represents an adaption rate and n represents a counter that is incremented for each hop or trainings stage. The counter may be similar to the counter discussed above.

In this example, completion tracking information may include a starting accuracy set at the MED 440 and the adaption rate(α). The starting accuracy may be an accuracy determined during design of the machine learning model 430a or may be a result of applying the machine learning model 430a to the test data set. The starting accuracy may be indicative of a ratio of instances that the machine learning model correctly classified test data over the number of items in the test data set (e.g., in the case of road signs, how many road signs the model correctly identified over the number of images in the test data set). Thus, starting accuracy may be a number between 0 and 1 (e.g., 100% accuracy). The adaption rate can be tunable parameter used to set a desired amount of training. For example, a larger adaption rate corresponds to more training and a smaller adaption rate corresponds to less training.

Each connected vehicle 410a-410n, in this example, computes current condition in the form of a change in accuracy (AA) after each respectively executed training stage and updates the accuracy threshold using Eq. 4 by incrementing the counter (n). Each connected vehicle 410a-410n compares the change in accuracy (AA) to the accuracy threshold (t) and determines a destination for a distributed machine learning message based on the comparison. For example, a connected vehicle transmits its trained machine learning model to MED 440 where that the change in accuracy (AA) satisfies (e.g., is equal to or larger than) the accuracy threshold (t). Otherwise, the connected vehicle provides its trained machine learning model to a next client as described above in connection with FIG. 4.

In an example implementation, completion information 710 may comprise a starting accuracy (A₀) of 0.3 and an adaption rate(α) se to 0.2, with a counter (n) initially set to zero. In this example, MED 440 selects connected vehicle 410b as an initial client, as described above in connection with FIG. 4, and transmits a distributed machine learning message that includes the machine learning model 430a and the completion information 710. Connected vehicle 410b accesses completion information 710 to obtain the completion criteria (e.g., accuracy threshold) and completion tracking information (e.g., test data set, starting accuracy (A₀), adaption rate (α), and counter (n)). After generating machine learning model 430b, connected vehicle 410b determines current conditions (e.g., change in accuracy (ΔA)) of the machine learning model 430b by applying the test data set thereto and measuring the accuracy (A₁) of the machine learning model 430b. The change in accuracy (ΔA) can be computed as the difference between A₁ and A₀. Connected vehicle 410b also increments the counter (n) to 1 and computes the accuracy threshold (t) using Eq. 4. In this example, the change in accuracy (ΔA) may be computed as 0.1 and t may be 0.2 (e.g., 0.2 divided by 1). Since the current conditions (e.g., the change in accuracy (ΔA)) of the model do not satisfy the completion criteria (e.g., are less than the accuracy threshold (τ)), connected vehicle 410b updates the completion information 710 to include the incremented counter (n), along with the adaption rate (α), the accuracy (A₀), and test data set as originally provided. Connected vehicle 410b then packages its machine learning model 430b with updated completion information 710 as a distributed machine learning message, which is provided to a next selected client as described in connection with FIG. 4.

Continuing with the above example, connected vehicle 410b may select connected vehicle 410n as the next client for training. As such, connected vehicle 410n receives the distributed machine learning message from connected vehicle 410b, which includes the machine learning model 430b and completion information 710. Connected vehicle 410n obtains completion criteria and completion tracking information from completion information 710. After generating machine learning model 430n, connected vehicle 410n determines current conditions (e.g., change in accuracy (ΔA)) of the machine learning model 430b by applying the test data set thereto, measuring the accuracy (Aₙ), and computing the difference between Aₙ and A₀. Connected vehicle 410n increments the counter (n) to 2 and computes the accuracy threshold (τ) using Eq. 4. In this example, the change in accuracy (ΔA) may be computed as 0.21 and t may be 0.1 (e.g., 0.2 divided by two). Responsive to determining that the current conditions satisfy the completion criteria, connected vehicle 410n provides machine learning model 430n to MED 440 to complete the distributed machine learning. In some examples, connected vehicle 410n may package the updated machine learning model 430n in a distributed machine learning message along with the completion information 710 and MED 440 may access the current conditions to verify that the training was complete (e.g., confirm that the current conditions satisfied the completion criteria at the MED 440).

In the foregoing example, model accuracy or accuracy ratio was used as an illustrative example of performance. However, embodiments disclosed herein are not intended to be limited to accuracy. Other measures of model performance may be utilized as desired for a given application, for example but not limited to, intersection over unit (IOU) loss, confusion or error matrix, precision and recall, F1-score, mean absolute error (MAE), mean square error (MSE), mean average precision, Area under Receiver operating characteristics curve (AUROC), etc.

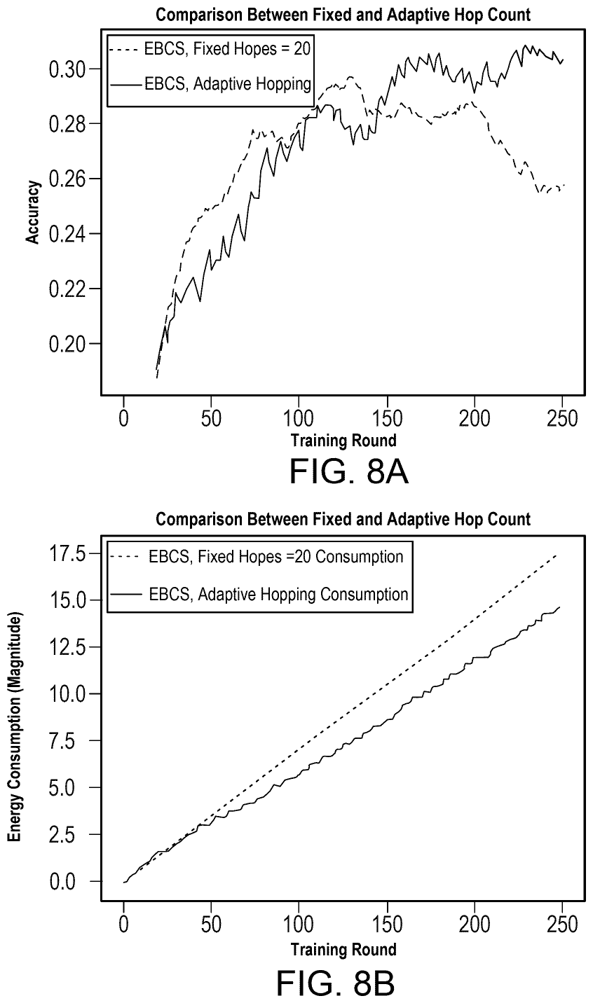

FIGS. 8A and 8B depict simulation results of distributed machine learning according using the adaptive hop stoppage technique compared to the fixed hop stoppage technique. The simulations used to provide FIGS. 8A and 8B were performed with training data distributed to clients in a simulated vehicular network, where the training data was non-IID data. FIG. 8A depicts accuracy (y-axis) as a function of number of training rounds of a machine learning model for: (a) fix hopes, where the number n of training stages or hops is set to 20; and (b) adaptive hops. FIG. 8B depicts energy consumption (y-axis) as a function of number of training rounds of a machine learning model for: (a) fixed hops; and (b) adaptive hops.

As shown in FIGS. 8A and 8B, the adaptive hopping technique provides for improvements over the fixed hops technique. For example, the adaptive hop technique provides a 10% improvement in energy consumption in this simulation. Furthermore, in this example simulation, the adaptive hop technique avoids overfitting the model (e.g., the decrease in accuracy reflected by the fixed hop technique) since the amount of training adapts overtime.

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 9. Various embodiments are described in terms of this example-computing component 900. After reading this description, it will become apparent to a person skilled in the relevant art how to implement the application using other computing components or architectures.

Referring now to FIG. 9, computing component 900 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 900 might also represent computing capabilities embedded within or otherwise available to a given device. For example, a computing component might be found in other electronic devices such as, for example, portable computing devices, and other electronic devices that might include some form of processing capability.

Computing component 900 might include, for example, one or more processors, controllers, control components, or other processing devices. This can include a processor, and/or any one or more of the components making up distributed machine learning system 200 of FIG. 2, distributed machine learning circuit 346 of FIG. 3, server 320 of FIG. 3, and/or model training circuit 316 of FIG. 3. Processor 904 might be implemented using a general-purpose or special-purpose processing engine such as, for example, a microprocessor, controller, or other control logic. Processor 904 may be connected to a bus 902. However, any communication medium can be used to facilitate interaction with other components of computing component 900 or to communicate externally.

Computing component 900 might also include one or more memory components, simply referred to herein as main memory 908. For example, random access memory (RAM) or other dynamic memory, might be used for storing information and instructions to be executed by processor 904. For example, memory 908 may store instructions that can be executed by processor 904 to perform operations described in connection with FIGS. 4 and 7. Main memory 908 might also be used for storing temporary variables or other intermediate information during execution of instructions to be executed by processor 904. Computing component 900 might likewise include a read only memory (“ROM”) or other static storage device coupled to bus 902 for storing static information and instructions for processor 904.

The computing component 900 might also include one or more various forms of information storage mechanism 910, which might include, for example, a media drive 912 and a storage unit interface 920. The media drive 912 might include a drive or other mechanism to support fixed or removable storage media 914. For example, a hard disk drive, a solid-state drive, a magnetic tape drive, an optical drive, a compact disc (CD) or digital video disc (DVD) drive (R or RW), or other removable or fixed media drive might be provided. Storage media 914 might include, for example, a hard disk, an integrated circuit assembly, magnetic tape, cartridge, optical disk, a CD or DVD. Storage media 914 may be any other fixed or removable medium that is read by, written to or accessed by media drive 912. As these examples illustrate, the storage media 914 can include a computer usable storage medium having stored therein computer software or data.

In alternative embodiments, information storage mechanism 910 might include other similar instrumentalities for allowing computer programs or other instructions or data to be loaded into computing component 900. Such instrumentalities might include, for example, a fixed or removable storage unit 922 and an interface 920. Examples of such storage units 922 and interfaces 920 can include a program cartridge and cartridge interface, a removable memory (for example, a flash memory or other removable memory component) and memory slot. Other examples may include a PCMCIA slot and card, and other fixed or removable storage units 922 and interfaces 920 that allow software and data to be transferred from storage unit 922 to computing component 900.

Computing component 900 might also include a communications interface 924. Communications interface 924 might be used to allow software and data to be transferred between computing component 900 and external devices. Examples of communications interface 924 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 924 may be carried on signals, which can be electronic, electromagnetic (which includes optical) or other signals capable of being exchanged by a given communications interface 924. These signals might be provided to communications interface 924 via a channel 928. Channel 928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 908, storage unit 920, media 914, and channel 928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 900 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for distributed machine learning, the method comprising:
obtaining, by a computing device, a first one or more model training metrics from a first one or more vehicles, wherein each of the first one or more model training metrics is based on diversity in training data stored at a respective vehicle of the first one or more vehicles and an estimate of energy consumed to train a machine learning model at the respective vehicle of the first one or more vehicles;
selecting a first vehicle from the first one or more vehicles based on the obtained first one or more model training metrics; and
transmitting the machine learning model to the selected first vehicle, wherein the selected first vehicle trains the machine learning model on training data stored at the selected first vehicle.

2. The method of claim 1, wherein the computing device is a mobile edge device of a distributed machine learning architecture.

3. The method of claim 2, wherein is the distributed machine learning architecture is a hybrid vehicular distributed machine learning architecture.

4. The method of claim 1, wherein is the computing device is one of a second vehicle and roadside equipment.

5. The method of claim 1, wherein the diversity in the training data stored at the respective vehicle is based on a measure of entropy of the training data stored at the respective vehicle.

6. The method of claim 1, wherein the estimate of energy consumed to train the machine learning model is based on historical energy consumption information obtained from historical training performed at the respective vehicle.

7. The method of claim 1, wherein each of the one or more model training metrics are a ratio of the diversity in the training data over the estimate of energy consumed to train the machine learning model.

8. The method of claim 7, further comprising:
determining the first vehicle is associated with the largest model training metric of the obtained one or more model training metrics,
wherein selecting the first vehicle is responsive to the determination.

9. The method of claim 1, further comprising:
obtaining, by the first vehicle, a second one or more model training metrics from a second one or more vehicles;
selecting a second vehicle from the second one or more vehicles based on the obtained first one or more model training metrics; and
transmitting the trained machine learning model, trained by the first vehicle, to the selected second vehicle.

10. The method of claim 9, further comprising:
determining, by the first vehicle, conditions of the trained machine learning model based on completion information received from the computing device, the completion information comprising completion criteria; and
responsive to a determination that the conditions satisfy the completion criteria, transmitting, by the first vehicle, the trained machine learning model to a mobile edge device;
wherein selecting the second vehicle and transmitting the trained machine learning model to the second vehicle is based on a determination that the conditions do not satisfy the completion criteria.

11. A computing device comprising:
a memory storing instructions and a machine learning model; and
one or more processors communicably coupled to the memory and configured to execute the instructions to:
obtain one or more model training metrics from one or more vehicles, wherein each of the one or more model training metrics is based on a measure of entropy in training data stored at a respective vehicle of the one or more vehicles and an estimate of energy consumed to train the machine learning model at the respective vehicle of the one or more vehicles;
select a vehicle from the one or more vehicles having the largest model training metric of the obtained one or more model training metrics; and
transmit the machine learning model to the selected vehicle.

12. The computing device of claim 11, wherein the computing device is one of a mobile edge device and a vehicle.

13. The computing device of claim 11, wherein the estimate of energy consumed to train the machine learning model is based on historical energy consumption information obtained from historical training performed by the one or more vehicles.

14. A vehicle comprising:
a memory storing instructions; and
one or more processors communicably coupled to the memory and configured to execute the instructions to:
based on a model training metric associated with the vehicle, receive a machine learning model and information indicative of a performance threshold for the machine learning model;
train the machine learning model;
measure a performance of the trained machine learning model; and
transmit the machine learning model to a remote computing device based on the measured performance being equal to or exceeding the performance threshold.

15. The vehicle of claim 14, wherein the information indicative of the performance threshold comprises a test data set, wherein the one or more processors are further configured to execute the instructions to:
apply the test data set to the trained machine learning model; and
measure the performance based on results of applying the test data set to the trained machine learning model.

16. The vehicle of claim 14, wherein the performance is one of accuracy of the machine learning model, intersection over unit loss, confusion or error matrix, precision and recall, F1-score, mean absolute error, mean square error, mean average precision, area under Receiver operating characteristics curve.

17. The vehicle of claim 14, wherein the one or more processors are further configured to execute the instructions to:
transmit the machine learning model to a remote vehicle based on the measured performance being less than the performance threshold.

18. The vehicle of claim 17, wherein the one or more processors are further configured to execute the instructions to:
obtain a one or more model training metrics from a one or more remote vehicles; and
select the remote vehicle from the one or more remote vehicles having the largest model training metric.

19. The vehicle of claim 14, wherein the memory stores training data, and wherein the model training metric is based on a measure of entropy in training data and an estimate of energy consumed to train the machine learning model.

20. The vehicle of claim 14, wherein the one or more processors are further configured to execute the instructions to:
transmit information indicative of the model training metric to one of the remote computing device and a first vehicle,
wherein the machine learning model and completion information is received based on the transmitted information.
